(19) United States
(12) Patent Application Publication
(10) Pub. No.: US 2013/0035617 A1
(43) Pub. Date: Feb. 7, 2013

(54) AEROBIC EXERCISE VIBRATION MACHINE

(71) Applicant: Morris Aboody, Toronto (CA)

(72) Inventor: Morris Aboody, Toronto (CA)

(73) Assignee: T-Zone Health, Inc., Toronto (CA)

(21) Appl. No.: 13/196,751

(22) Filed: Aug. 2, 2011

(51) Int. Cl. A61H 1/00

(52) U.S. Cl. 601/53

(57) ABSTRACT

A device and method for vibrational and aerobic exercise is disclosed. The system provides a vibrational exercise experience in conjunction with an oscillating means for simulating walking. The system provides the benefits of traditional aerobic exercise as well as all those of a vibrational machine in a low-impact, easy to use system.

### SCOPE OF INVENTION

The present invention relates to an exercise method and machine. More particularly, the present invention relates to a system for using vibrational movement to provide whole body aerobic exercise.

### BACKGROUND AND SUMMARY OF INVENTION

Existing vibrational exercise machines afford a wide range of health benefits including weight loss, muscle development, firming & toning, improved bone structure, reduced signs of aging, improved circulation, pain relief, rehabilitation of injuries, massage etc., but provide little in the way of aerobic exercise. Traditional exercise machines such as treadmills, stationary bicycles and elliptical machines provide aerobic exercise but do not afford all the additional benefits of a vibrational exercise machine. What is needed is a system that provides the benefits of both.

The present invention provides the benefits of oscillating vibrational exercise and adds an aerobic exercise component in an easy-to-use manner. It provides a wide range of health benefits in less time. The present invention generates less stress on the joints, ligaments and tendons when compared to regular resistance training. It is low impact and ergonomically designed and is suitable for use by all ages and body types.

In one embodiment, the present invention produces oscillating vibrations in an alternating side rocking manner, which simulates walking. The vibrational energy is safely and effectively transferred throughout the user's body, stimulating bone, muscle and all other soft tissue and is preferred to vertical vibration for a number of reasons.

A vertical (or linear) vibration machine simulates a jump for the user. In this scenario, muscles on both sides of the body contract simultaneously. The load on the body is very high and the repeated impact makes certain postures unsuitable, as well as limiting the suitability of this technology to people who are quite fit.

Although still somewhat popular, vertical vibration machines are disfavored because of possible long term injuries caused by overly aggressive machines with damaging compressions. This vertical movement is very intense and can be uncomfortable for most users. High quality machines are generally very expensive, noisy and not well suited to the domestic environment, whereas cheap machines are less noisy but are often not engineered appropriately. Vertical vibration machines are meant more for gyms with supervision by qualified personal trainers to avoid injury and ensure the correct positions are used during exercise. The personal trainer needs to fully understand the medical implications of vibration training on the body.

Additional features of the disclosure will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a first embodiment of the device;

FIG. 2 is a diagram showing vibrational energy being transmitted to a user according to one embodiment of the present system;

FIG. 3 is a diagram showing vibrational energy being transmitted to a user in a typical prior art vertical vibration machine system;

FIG. 4 is a perspective view of the base of the oscillating vibration machine of the first embodiment;

FIG. 5 is a front view of the base of the oscillating vibration machine of the first embodiment;

FIG. 6 is a side perspective view of the base of the oscillating vibration machine of the first embodiment;

FIG. 7 is a perspective view of the base of the oscillating vibration machine of a second embodiment;

FIG. 8 is a front view of the base of the oscillating vibration machine of the second embodiment;

FIG. 9 is a side view of the base of the oscillating vibration machine of the second embodiment; and

FIG. 10 is a perspective view of the oscillating vibration machine of a third embodiment.

### DETAILED DESCRIPTION OF THE DRAWINGS

The presently disclosed device and method (herein alternatively referred to as a “system”) provides users with a means to achieve an aerobic workout experience as well as realize all the benefits associated with vibrational exercise technology.

Oscillating vibrational machines “see-saw” from side to side. The “see-saw” motion stimulates the right and left brain in a manner that facilitates communication between the two sides. This stimulation is known as patterning. There are many benefits to a patterning exercise, including better co-ordination and balance.

Two important variables with oscillating vibrational machines are the speed/frequency (i.e. how often the plate moves up and down) and the amplitude (i.e. how far up and down the plate moves). The amplitude can be controlled by the machine or by the distance between the left and right feet. The muscles affected when using an oscillating vibrational machine are contracted alternately—the same muscle on both sides of the body is never engaged at the same time.

This oscillating motion complements or mimics the neuro-muscular response we experience with walking. As the rhythmic movement of the platform reaches the tops of your legs, the pelvis is gently mobilized rather than compacted. Then, all your pelvic and core muscles at the front and trunk of your torso are activated, while the snake-like movement repeats throughout your spinal vertebrae. This helps mobilization, clearing stagnant fluids and inflammation, and allowing fresh oxygenated blood to enter.

This gentle rhythmic motion also has the effect of pumping the discs. Chiropractors find that this pumping of the discs helps the patient get pain relief faster while holding the adjustment longer. A natural movement pattern similar to walking encourages improved posture (walking activates alternate muscles on either side of the body, never the same muscle on the left and right side). Users can adjust the amplitude simply by moving their feet closer or further apart. This would have no affect on a vertical vibration plate where the amplitude is fixed.

Additionally, tensor and flexor muscles are activated alternately causing immediate activation of your core muscles, toning your abdomen. This also reduces head vibrations—vertical vibrations exit via the head whereas oscillatory vibrations are dampened in the core abdominal region.

The user's body reacts to this natural stimulus with an involuntary reflex body reaction. Depending on the speed, a user's muscles will react up to 30 times per second and as the acceleration forces increase; the user's body will feel as though it “weighs” more. This means a user can work against a far greater influence or “load” of gravity in every movement.

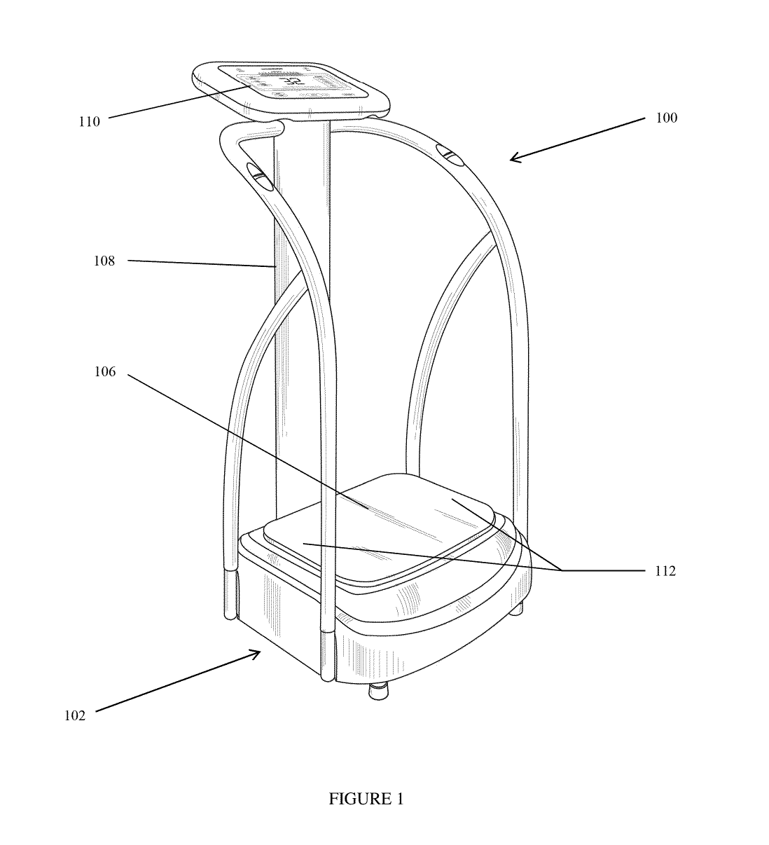

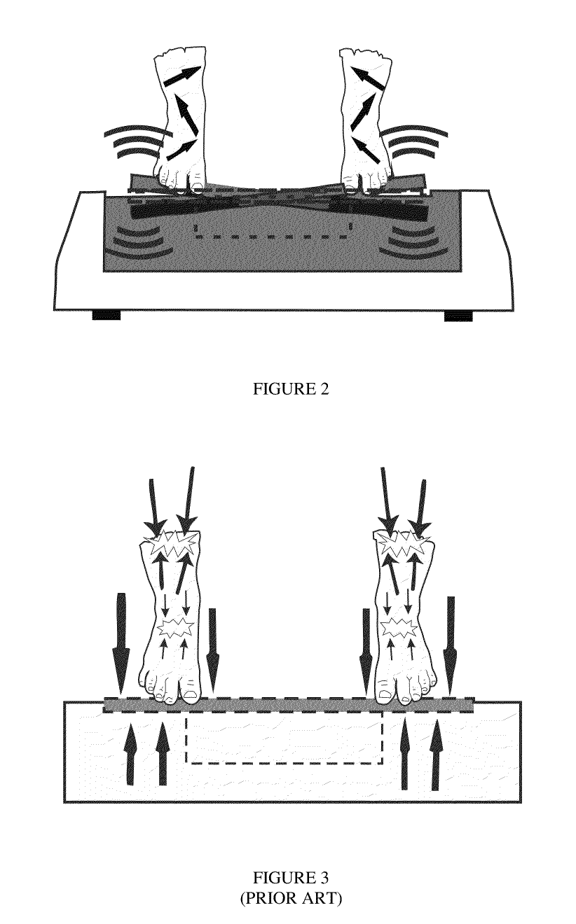

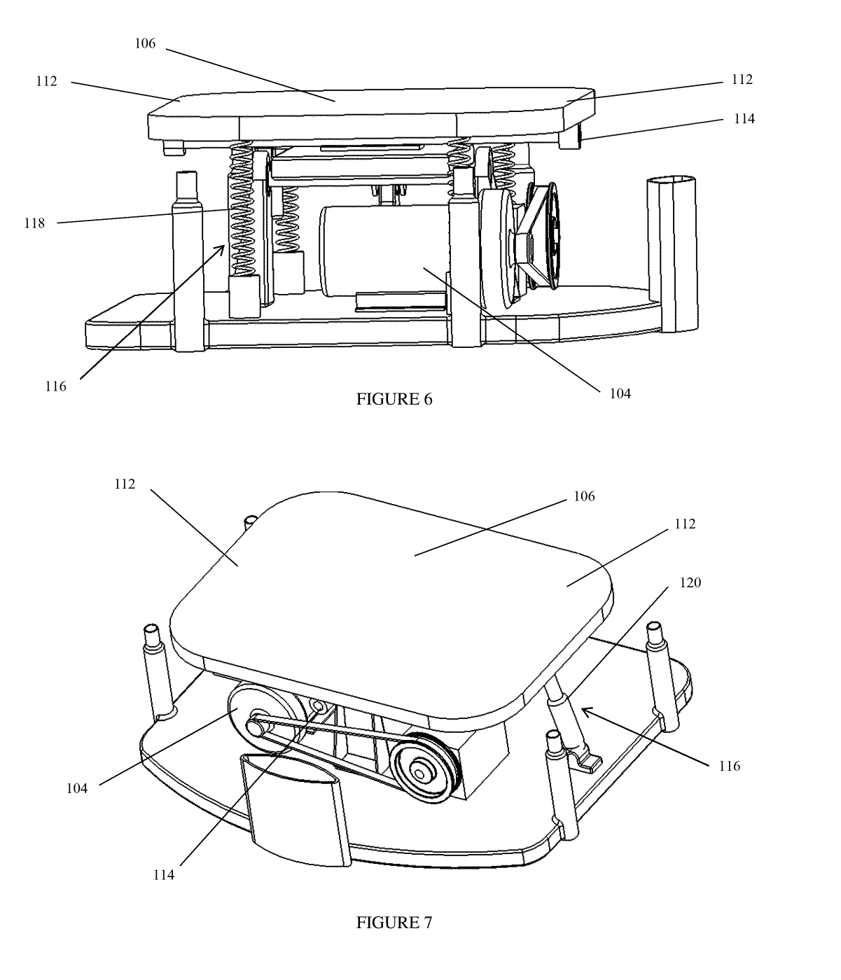

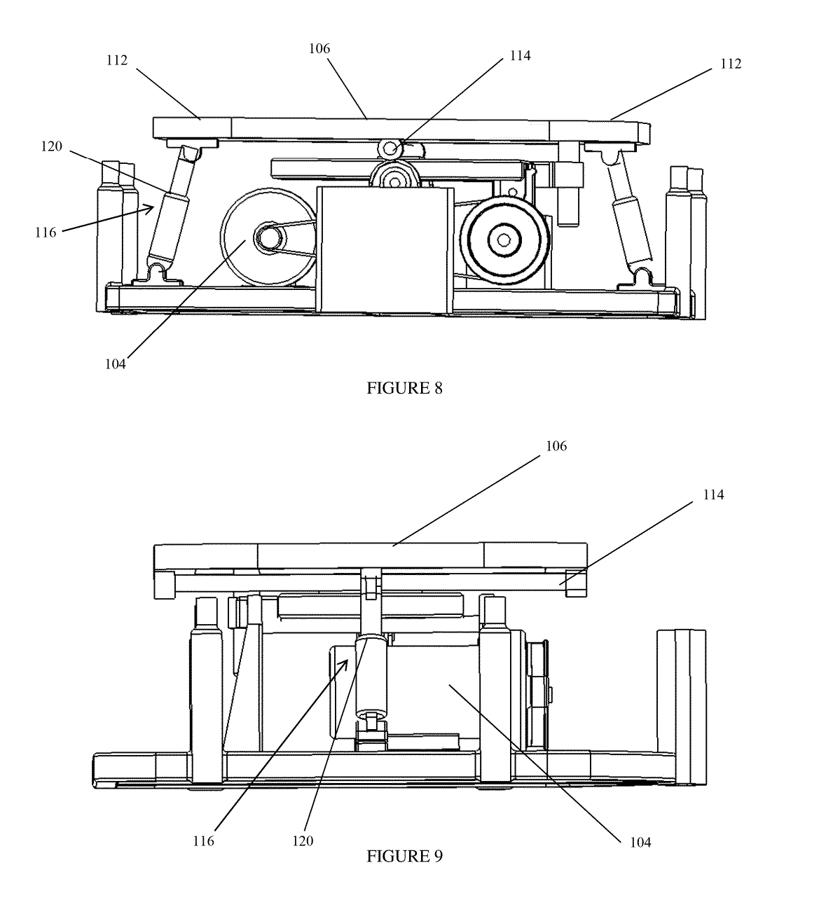

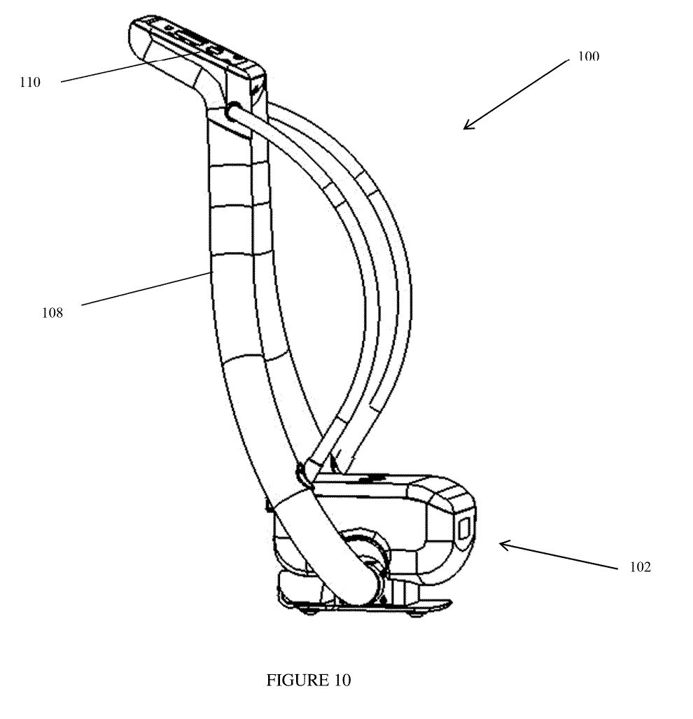

As shown in FIG. 1, the first embodiment of the system 100 consists of a base 102 having a motor 104 which serves as a means for generating vibrations and/or oscillating motion, platform 106, one or more vertical supports 108 and a control interface 110 providing a means for user control of the vibrations and/or oscillating motion. During operation, the user stands on the platform 106 and the system transmits vibrational energy to the user. The system is also capable of simultaneously moving each side 112 of platform 106 in an alternating up and down motion about a central pivot axis 114, as shown in FIGS. 2 and 4-9.

This alternating motion simulates walking and provides an aerobic exercise to the user. Additionally, the walking motion facilitates the transmission of the vibrational energy to the user. As shown in FIGS. 2 and 3, transmission of vibrational energy to a user on a static platform tends to become concentrated in particular areas of the body and may impart its effects unevenly, diminishing the beneficial effects of the system and even becoming uncomfortable or painful after prolonged use. The up and down alternating motion of the platform sides reduces the undesired concentration of the vibrational energy in particular regions of the body and the deleterious effects associated therewith. By transmitting the vibrational energy to the user during the walking motion, the energy is distributed more evenly throughout the human body than would be the case with a static platform and thus enhances all of the beneficial effects otherwise associated with a typical vibrational exercise system.

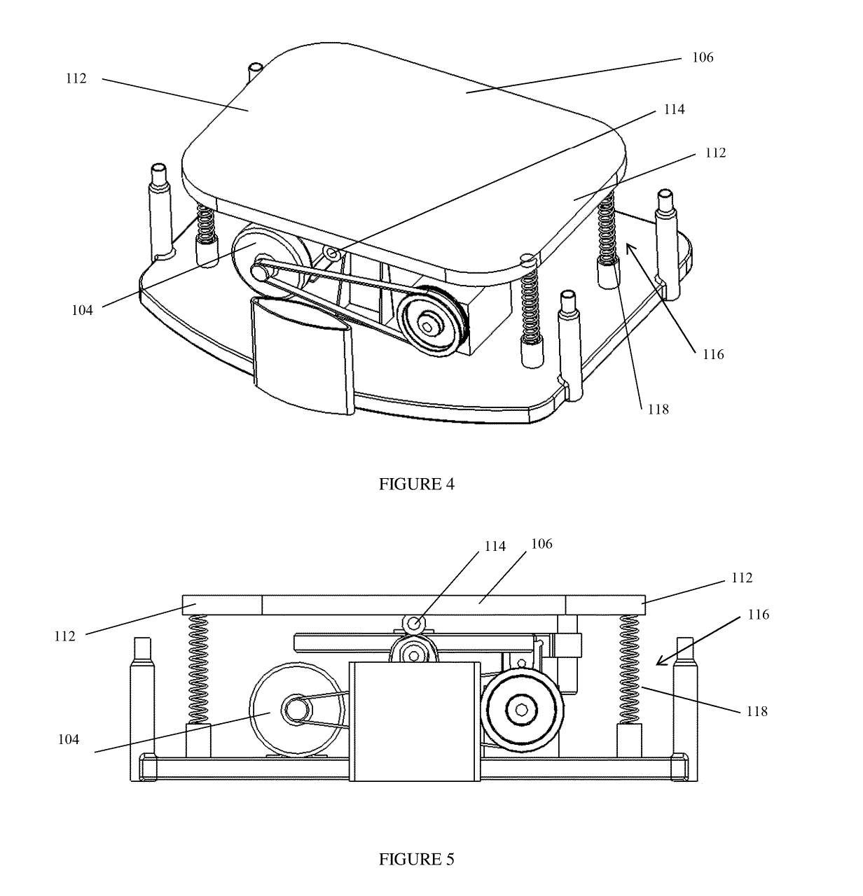

The present system provides a resistive aerobic workout, while simultaneously using the user's movements to facilitate the delivery of the vibrational energy in an oscillating manner. FIGS. 4-6 show the components located in the base 102 of the system 100 according to the first embodiment of the invention. The motor 104, through a pulley/rod system (or any other appropriate method), causes the platform to oscillate like a “teeter-totter”. Platform 106 is also connected separately to the base by one or more resistance mechanisms 116.

In the embodiment of FIGS. 4-6, the resistance mechanisms comprise springs 118. The user can optionally use these mechanisms for aerobic exercise by alternating his/her weight from one foot to the other. In an alternate configuration shown in FIGS. 7-9 the resistance mechanism comprises hydraulic cylinders 120. The speed and force supplied by the motor 104 as well as the amount of force provided by the resistance mechanisms may be controlled by the user.

The control interface 110 permits the user to select and adjust a wide range of operational parameters and may display current or target information regarding the same. Specifically, the user may select vibrational speed and intensity as well as the speed and resistance associated with the oscillating motion of the platform sides 112. The user may select from pre-set operational programs and/or the adjustment of the parameters may be selected based on the particular needs/capabilities of the user. Specifically, the user may further customize his/her experience by inputting personal parameters such as age, weight or a target. As shown in FIGS. 1 and 10, the control interface display facilitates the entry of parameters and provides useful information such as calories burned, elapsed time, pulse rate etc.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

A plurality of advantages arises from the various features of the present disclosure. It will be noted that alternative embodiments of various components of the disclosure may not include all of the features described yet still benefit from at least some of the advantages of such features. Those of ordinary skill in the art may readily devise their own implementations of a digital file organization system that incorporate one or more of the features of the present disclosure and fall within the spirit and scope of the disclosure.

What is claimed is:

1. An aerobic exercise machine having a platform for supporting a standing user, the aerobic exercise machine comprising:
a motor causing opposite ends of the platform to oscillate in an up and down motion about a central pivot axis;
one or more mechanical resistance members for influencing the oscillating motion;
wherein said motor generates vibrations that are transmitted to the user through the platform; and
where said oscillating motion causes the vibrations to be delivered in an alternating manner to each of the user's feet through the platform.

2. The aerobic exercise machine of claim 1, further comprising a control interface.

3. The aerobic exercise machine of claim 2, wherein said control interface permits a user to control the vibrations and the oscillating motion.

4. The aerobic exercise machine of claim 1, further comprising a display device capable of displaying information relating to at least one of the group consisting of oscillating motion, vibrations, and user information.

5. A vibrational machine having a platform for supporting a standing user, the vibrational machine comprising:
a motor causing opposite ends of the platform to oscillate in an up and down motion about a central pivot axis;
one or more mechanical resistance members for influencing the oscillating motion; and
a means for generating vibrations that are transmitted to the user.

6. The vibrational machine of claim 5, wherein said motor generates said vibrations.

7. The vibrational machine of claim 5, wherein said oscillating motion provides aerobic exercise.

8. The vibrational machine of claim 5, wherein said oscillating motion causes the vibrations to be delivered in an alternating manner to each of the user's feet through the platform.

9. The vibrational machine of claim 5, wherein said machine comprises a control interface.

10. The vibrational machine of claim 9, wherein said control interface provides a user with control of the vibrations.

11. The vibrational machine of claim 9, wherein said control interface provides a user with control of the oscillating motion.

12. The vibrational machine of claim 5, wherein said machine comprises a display device capable of displaying information relating to at least one of the group consisting of oscillating motion, the vibrations, or user information.

13. A method of transmitting vibrations through a support platform to a standing user comprising:
a means for causing opposite ends of the platform to oscillate in an up and down motion about a central pivot axis;
a means for providing resistance to the oscillating motion; and
a means for generating vibrations and transmitting the vibrations to the user.

14. The machine of claim 13, wherein said means for causing opposite ends of the platform to oscillate and said means for generating vibrations are powered by a single motor.

15. The method of claim 13, wherein said oscillating motion provides aerobic exercise.

16. The method of claim 13, wherein said oscillating motion causes the vibrations to be delivered in an alternating manner to each of the user's feet through the platform.

17. The method of claim 13, wherein said method comprises a means for user control.

18. The method of claim 16, wherein said control interface permits control of the vibrations.

19. The method of claim 16, wherein said control interface permits control of the oscillating motion.

20. The method of claim 13, wherein said method comprises a means for displaying information relating to at least one of the group consisting of oscillating motion, vibrations, and user information.
